(19) United States
(12) Patent Application Publication
(10) Pub. No.: US 2008/0053265 A1
(43) Pub. Date: Mar. 6, 2008

(54) Pedal assembly

(76) Inventor: Sean A. Bannon, Bloomfield, MI (US)

Correspondence Address: DAIMLERCHRYSLER INTELLECTUAL CAPITAL CORPORATION;CIMS 483-02-19, 800 CHRYSLER DR EAST, AUBURN HILLS, MI, 48326-2757, US

(21) Appl. No.: 11/469,508

(22) Filed: Sep. 1, 2006

(51) Int. Cl. G05G 1/14

(52) U.S. Cl. 74/512

(57) ABSTRACT

A brake pedal assembly for a motor vehicle includes a first link pivotally mounted on a bulkhead bracket, and a first pulley mounted for rotation on a vehicle cross member positioned rearward of the bulkhead. A brake pedal lever arm is pivotally mounted on either the firewall bracket or the cross member, while a cable passing over the pulley couples a lever arm defined on the first link with a cable attachment point on the brake pedal lever arm. In the event of a rearward displacement of the bulkhead during a collision, the flexible cable slackens to allow the pedal lever arm to move forward, away from the legs of the vehicle operator.

### FIELD OF THE INVENTION

The invention relates generally to vehicle pedal assemblies.

### BACKGROUND OF THE INVENTION

While many interior components of modern vehicles are configured to minimize injury to vehicle occupants in the event of a collision, conventional foot pedal assemblies, such as the brake pedal, clutch pedal, and acceleration pedal assemblies, which are housed in a pedal box mounted to the vehicle's cowl structure or “bulkhead” immediately forward of the vehicle operator's lower leg below the vehicle's instrument panel, continue to transfer collision-induced impact forces to the operator's leg. Likewise, the reaction of the occupant in the collision can force the occupant's legs against the foot pedals assemblies. And, for foot pedal assemblies employed with hydraulic-fluid-actuated systems such as the vehicle's brake pedal assembly, in the event of a frontal collision, the valve body or “plunger” of the brake system's master cylinder extending through of the bulkhead tends to push the brake pedal lever rearward, often far beyond the normal brake release position, with a further possibility of causing significant injury to the operators legs.

One known approach to minimizing such forces during a severe frontal collision includes modifying the manner in which the pedal lever arm is pivotally supported within the bulkhead-mounted pedal box, such that movement of the bulkhead relative to a rigid structure, such as a separate vehicle cross member, causes a failure in the pedal supporting structure, thereby allowing the pedals to move freely with little constraint following a frontal collision. Other known approaches include the use of mechanical connections, such as either a plurality of rigid links or a cable extending between the bulkhead-mounted pedal and the relatively-stable interior structure to define a pedal pivot point that is actively repositioned upon rearward movement of the bulkhead, whereby the pedal is again free to move with little constraint. However, such approaches often render the pedal assemblies completely inoperative following a frontal collision.

What is needed, then, is a pedal assembly for use in a vehicle that reduces both the intrusion forces imparted to a vehicle operator during a frontal collision, and the forces imparted to the operator as his leg reacts against the pedal assembly during such a collision, preferably without rendering the pedal assembly completely inoperative in all but the most severe collisions.

### SUMMARY OF THE INVENTION

In accordance with an aspect of the invention, a pedal assembly is provided for an automotive vehicle, wherein the vehicle includes a cowl structure or bulkhead positioned generally forward of a seating position for a vehicle operator, and a rigid cross member spaced generally rearward of the bulkhead. The pedal assembly includes a link supported by the bulkhead for pivoting movement about a link pivot axis, as through use of a first bracket mounted on interior side of the bulkhead. The link includes a first link lever arm and, in a preferred embodiment, also a second link lever arm. While the first and second link lever arms may be disposed at any suitable angle with respect to each other, in a preferred embodiment, the first link lever arm is generally diametrically opposite from the second link lever arm, relative to the link pivot axis. Also, in a preferred embodiment, the end of the second link lever arm is coupled to the plunger of a master cylinder, whereby the pedal assembly is operative to actuate the vehicle's wheel braking system.

The pedal assembly also includes a first pulley mounted on the cross member for rotation about a first pulley axis, wherein the first pulley axis is spaced from the link pivot axis. While the invention contemplates other relative geometries, including those in which the first pulley axis nominally stands askew to the link pivot axis, in a preferred embodiment, the link pivot axis is generally parallel to the first pulley axis.

The pedal assembly further includes an elongate pedal lever arm that is pivotally supported by one of the bulkhead and the cross member, as through use of a suitable mounting bracket on either the bulkhead or the cross member. The pedal lever arm also has an end adapted to support a pedal pad generally rearward of the bulkhead.

The pedal assembly further includes a flexible cable having a first end attached to the first link lever arm, and a cantilevered second end attached to the pedal lever arm at a first distance from the pedal lever arm's pivot point. An intermediate portion of the cable passes over the first pulley to thereby define a first cable section extending between the first link lever arm and the first pulley, and a second cable section extending between the first pulley and the pedal lever arm, whereby a rearward displacement of the bulkhead relative to the cross member during a vehicle collision will feed the cable past the first pulley to thereby lengthen the second cable section between the first pulley and the pedal lever arm and, hence, allow the pedal pad to move generally forward, away from the seating position for the vehicle operator.

In accordance with a further aspect of the invention, in a preferred embodiment, the pedal lever includes a cam surface, with the second cable section passing over the cam surface. In this manner, the cam surface operates to increase a tensile force applied to the cable by the pedal lever arm with increasing forward displacement of the pedal pad.

In accordance with yet another aspect of the invention, in a preferred embodiment wherein the pedal lever arm is supported by a bulkhead bracket, the pedal assembly includes a second pulley, mounted on the bulkhead bracket for rotation about a second pulley axis. In this embodiment, the second section of the cable between the first pulley and the pedal lever arm is passed over the second pulley. It will be appreciated that the first and second pulley axes can be canted relative to one another, to thereby permit a lateral shift within the vehicle interior of the pedal lever arm pivot point and the link/master cylinder plunger, thereby facilitating a repositioning of the master cylinder within the vehicle to better accommodate other mechanical and electrical vehicle systems.

From the foregoing, it will be appreciated that the invention advantageously permits the cable to slacken as the bulkhead (more specifically, the bulkhead bracket) is displaced rearwardly toward the cross member (more specifically, the cross member bracket) during a collision, such that the pedal pad will move away from the vehicle operator. Further, to the extent that the bulkhead is not rearwardly displaced during a collision so much so that the slackened cable allows the pedal lever arm to pivot into engagement with another interior structure of the vehicle, it will be appreciated that a pedal assembly in accordance with the invention may beneficially still provide some pedal function even after such a collision.

Other objects, features, and advantages of the present invention will be readily appreciated upon a review of the subsequent description of the preferred embodiment and the appended claims, taken in conjunction with the accompanying Drawings.

### BRIEF DESCRIPTION OF THE DRAWINGS

FIG. 1 is a partial, diagrammatic, cross-sectional view of a vehicle operator seated in a vehicle, immediately behind a first exemplary brake pedal assembly in accordance with the invention (the bulkhead-mounted bracket of which is partially broken away for clarity of illustration);

FIG. 2 is an enlarged view of the first brake pedal assembly of FIG. 1; and

FIG. 3 is an enlarged view of a second brake pedal assembly in accordance with another aspect of the invention.

### DETAILED DESCRIPTION OF THE PREFERRED EMBODIMENTS

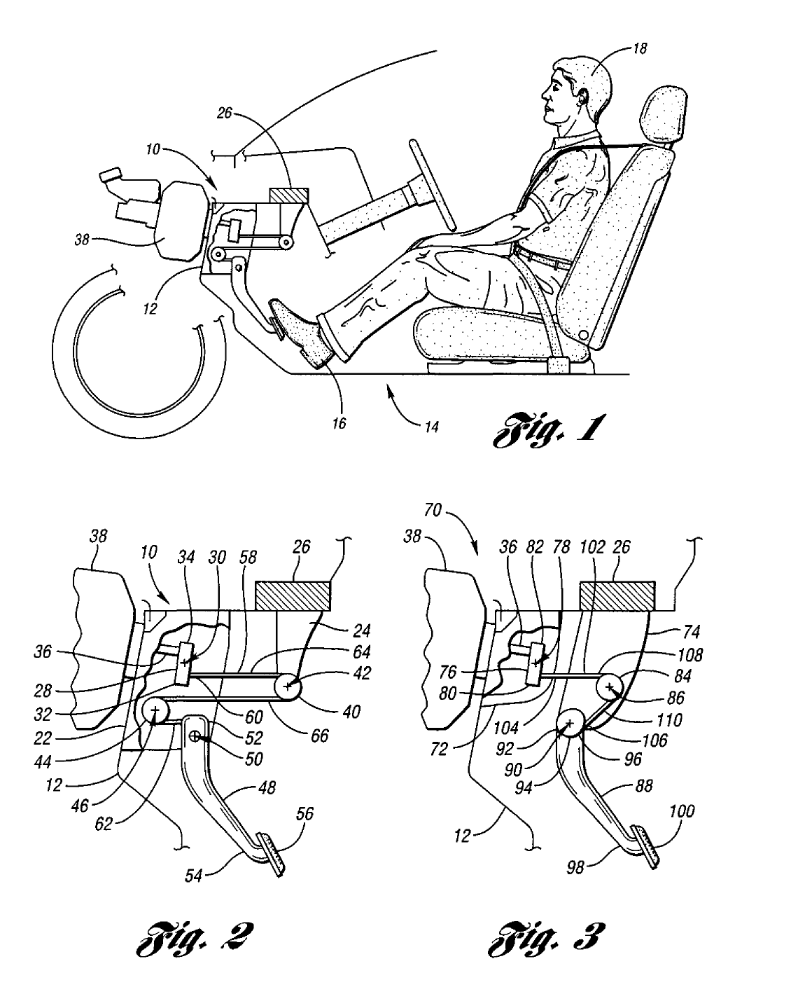

Referring to FIG. 1, a first exemplary brake pedal assembly 10 in accordance with the invention is mounted on the cowl structure or bulkhead 12 of a motor vehicle 14, just forward of the right foot 16 of a vehicle operator 18 seated in the vehicle 14. The first brake pedal assembly 10 includes a bracket 22 mounted on the interior side of the bulkhead 12, and a bracket 24 mounted on a rigid vehicle cross member 26 spaced generally rearward of, and slightly above, the bulkhead 12.

As best seen in the enlarged view of FIG. 2, a link 28 is supported by the bulkhead bracket 22 for pivoting movement about a link pivot axis 30. The link 28 includes a first link lever arm 32 and a diametrically-opposite second link lever arm 34. The second link lever arm 34 is coupled to the plunger 36 of a master cylinder 38 that is itself mounted to the engine side of the bulkhead 12, but whose plunger 36 extends through the bulkhead 12 in a generally longitudinal direction.

Referring again to FIG. 2, the first brake pedal assembly 10 also includes a first pulley 40 mounted on the cross member bracket 24 for rotation about a first pulley axis 42. The first pulley axis 42 is spaced an appreciable distance from, and is generally parallel to, the link pivot axis 30. A second pulley 44 is mounted on the bulkhead bracket 22 for rotation about a second pulley axis 46. An elongate pedal lever arm 48 is pivotally supported by the bulkhead bracket at a pivot point 50. The pedal lever arm 48 has a first end 52, and a second end 54 adapted to support a pedal pad 56 generally rearward of the bulkhead 12.

Also as seen in FIG. 2, the first brake pedal assembly 10 further includes a flexible cable 58 having a first end 60 attached to the first link lever arm 32, and a second end 62 attached to the pedal lever arm 48 at a first distance from the pedal lever arm's pivot point 50, proximate to the first end 52 of the pedal lever arm 48. An intermediate portion of the cable 58 winds around both the first pulley 40 and the second pulley 44 to thereby define a first cable section 64 extending between the first link lever arm 32 and the first pulley 40, and a second cable section 66 extending between the first pulley 40 and the first end 52 of the pedal lever arm 48.

In operation, a rearward displacement of the bulkhead 12 relative to the cross member 26 during a vehicle collision will feed the flexible cable 58 past the first pulley 40 and the second pulley 44, thereby creating slack in the cable 58 to effectively lengthen the second cable section 66 between first pulley 40 and the pedal lever arm 48 (and, even more specifically, between the second pulley 44 and the pedal lever arm 48). The pedal lever arm 48 will then rotate about the pivot point 50 such that the pedal pad 56 will move generally forward, away from the seating position for the vehicle operator.

Referring to FIG. 3, a second exemplary brake pedal assembly 70 in accordance with the invention is mounted on the vehicle bulkhead 12. As in the first brake pedal assembly 10, the second brake pedal assembly 70 includes a bracket 72 mounted on the interior side of the bulkhead 12, and a bracket 74 mounted on the rigid vehicle cross member 26 spaced generally rearward of, and slightly above, the bulkhead 12. The second brake pedal assembly 70 similarly includes a link 76 supported by the bulkhead bracket 72 for pivoting movement about a link pivot axis 78. The link 76 likewise includes a first link lever arm 80 and a diametrically-opposite second link lever arm 82, with the second link lever arm 82 being coupled to the plunger 36 of a bulkhead-mounted master cylinder 38. A first pulley 84 is likewise mounted on the cross member bracket 74 for rotation about a first pulley axis 86, with the first pulley axis 86 being spaced an appreciable distance from, and generally parallel to, the link pivot axis 78.

As seen in FIG. 3, the second brake pedal assembly 10 includes an elongate pedal lever arm 88 pivotally supported by the bulkhead bracket 72 at a pivot point 90. The pedal lever arm 88 has a first end 92 to which a cam 94 is secured to thereby define a cam surface 96 that rotates with the pedal lever arm 88 about the pivot point 90. The pedal lever arm 88 also has a second end 98 adapted to support a pedal pad 100 generally rearward of the bulkhead 12.

A flexible cable 102 has a first end 104 attached to the first link lever arm 80, and a second end 106 attached to the cam surface 96 of the pedal lever arm 88. An intermediate portion of the flexible cable 102 passes over the first pulley 84 to thereby define a first cable section 108 extending between the first link lever arm 80 and the first pulley 84, and a second cable section 110 extending between the first pulley 84 and the cam surface 96 of the pedal lever arm 88.

It will be appreciated that the profile of the cam surface 96 preferably operates to increase a tensile force applied to the flexible cable 102 by the pedal lever arm 88 with increasing forward displacement of the pedal pad 100, whereby an improved brake pedal effort can be achieved. And, while the invention contemplates forming the cam surface 96 integrally with the pedal lever arm 88, because the cam surface 96 is conveniently define by a separate cam 94 that is secured to the pedal lever arm 88 for rotation about the pivot point 90, the second brake pedal assembly 20 advantageously facilitates selection of a preferred pedal ratio by simply selecting one of several available cams, each with its own cam profile, providing an improved pedal response and “feel.”

In operation, a rearward displacement of the bulkhead 12 relative to the cross member 26 during a vehicle collision will feed the flexible cable 102 past the first pulley 84, thereby creating slack in the cable 102 to effectively lengthen the second cable section 110 between first pulley 84 and the cam surface 96 on the pedal lever arm 88. The pedal lever arm 88 will then rotate about the pivot point 90 such that the pedal pad 100 will move generally forward, away from the seating position for the vehicle operator.

While the above description constitutes the preferred embodiments, it will be appreciated that the invention is susceptible to modification, variation and change without departing from the proper scope and fair meaning of the subjoined claims. For example, while the preferred embodiments each position the link on the passenger compartment-side of the bulkhead, it will be appreciated that the invention contemplates placement of the link on the engine compartment-side of the bulkhead, with the first cable section thereby passing through the bulkhead in any suitable manner. And, while the bulkhead-supported link has a central pivot point thereby defining its two lever arms, it will be appreciated that the invention contemplates use of a single lever arm defined through use of a link pivot point proximate to an end of the link, for example, with both the master cylinder's plunger and the first end of the cable being coupled or attached to the link's sole lever arm.

Further, while the preferred embodiments each show the brake system's master cylinder positioned such that its plunger extends generally longitudinally of the vehicle (through the bulkhead), it will be appreciated that the first and second link lever arms of the link may be defined, for example, with a relative angle of ninety degrees between the link lever arms, to thus allow the master cylinder's plunger to extend generally transversely of the vehicle, for example, generally parallel to the bulkhead on the engine side thereof, providing even greater flexibility in vehicle component “packaging.” Similarly, while the preferred embodiments rely upon gravity, as well as any nominal force applied by the drivers foot, to maintain a minimal tension in the cable during normal vehicle operation, the invention contemplates use of a suitable spring, such as a clock spring mounted proximate to the pedal lever arm pivot point, operative to apply a nominal cable-tensioning bias to the pedal lever arm.

What is claimed is:

1. A pedal assembly for an automotive vehicle, wherein the vehicle includes a bulkhead positioned generally forward of a seating position for a vehicle operator, and a rigid cross member spaced generally rearward of the bulkhead, the assembly comprising:
a link supported by the bulkhead for pivoting movement about a link pivot axis, the link including a first link lever arm;
a first pulley mounted on the cross member for rotation about a first pulley axis, wherein the first pulley axis is spaced from the link pivot axis;
an elongate pedal lever arm pivotally supported by one of the bulkhead and the cross member, the pedal lever arm having a free end extending to a position generally rearward of the bulkhead; and
a flexible cable having a first end attached to the first link lever arm, a second end attached to the pedal lever arm at a first distance from the pivot point, and an intermediate portion passing over the first pulley to thereby define a first section of the cable extending between the first link lever arm and the first pulley, and a second section of the cable extending between the first pulley and the pedal lever arm,
whereby a rearward displacement of the bulkhead relative to the cross member feeds the cable past the pulley, thereby lengthening the second section of the cable.

2. The pedal assembly of claim 1, wherein the pedal lever includes a cam surface, and wherein the second section of the cable passes over the cam surface.

3. The pedal assembly of claim 2, wherein the cam surface operates to increase a tensile force applied to the cable by the pedal lever arm with increasing forward displacement of the free end of the pedal lever arm.

4. The pedal assembly of claim 2, wherein the cam surface is defined by a selected one of a plurality of cams that Is secured to the pedal lever arm for rotation about the pivot point, each cam featuring a different cam profile.

5. The pedal assembly of claim 1, wherein the link includes a second link lever arm adapted to actuate a brake master cylinder.

6. The pedal assembly of claim 1, wherein the second link lever arm is positioned generally diametrically opposite from the first lever arm, relative to the link pivot axis.

7. The pedal assembly of claim 1, wherein the first pivot axis is generally parallel to the first pulley axis.

8. The pedal assembly of claim 1, including a second pulley supported by the bulkhead for rotation about a second pulley axis, and wherein the second cable section passes over the second pulley.

9. A brake pedal assembly for actuating a master cylinder of an automotive vehicle, wherein the master cylinder includes a plunger, and wherein the vehicle includes a bulkhead positioned generally forward of a seating position for a vehicle operator, and a rigid cross member spaced generally rearward of the bulkhead, the pedal assembly comprising:
a link mounted on the bulkhead for pivoting movement about a first pivot axis, the link including a first link lever arm and a second lever arm, the second lever arm being coupled to the plunger of the master cylinder;
a first pulley mounted on the cross member for rotation about a first pulley axis, wherein the first pulley axis is spaced from the first link pivot axis;
a pedal lever arm including an elongate pedal lever arm pivotally supported by one of the bulkhead and the cross member, the pedal lever arm having a free end defining a pedal pad generally rearward of the bulkhead; and
a flexible cable having a first end coupled to the first link lever arm, a second end coupled to the pedal lever arm at a first distance from the pivot point, and an intermediate portion passing over the first pulley to thereby define a first section of the cable extending between the first link lever arm and the first pulley, and a second section of the cable extending between the first pulley and the pedal lever arm,
whereby a rearward displacement of the bulkhead relative to the cross member feeds the cable past the pulley, thereby lengthening the second cable section to allow the pedal pad to move generally forward, away from the seating position for the vehicle operator.

10. The pedal assembly of claim 9, wherein the pedal lever arm includes a cam surface, and the second section of the cable engages the cam surface.

11. The pedal assembly of claim 10, wherein the cam surface operates to increase a tensile force applied to the cable by the pedal lever arm with increasing forward displacement of the pedal pad.

12. The pedal assembly of claim 11, wherein the cam surface is defined by a selected one of a plurality of cams that Is secured to the pedal lever arm for rotation about the pivot point, each cam featuring a different cam profile.

13. The pedal assembly of claim 9, wherein the second link lever arm is positioned generally diametrically opposite from the first lever arm, relative to the link pivot axis.

14. The pedal assembly of claim 9, wherein the first pivot axis is generally parallel to the first pulley axis.

15. The pedal assembly of claim 9, including a second pulley mounted on the bulkhead for rotation about a second pulley axis, and wherein the second cable section passes over the second pulley.
